(19) United States
(12) Patent Application Publication
(10) Pub. No.: US 2024/0061977 A1
(43) Pub. Date: Feb. 22, 2024

(54) DATA INFORMED OCEAN SIMULATIONS

(71) Applicant: X Development LLC, Mountain View, CA (US)

(72) Inventors: Julia Black Ling, Redwood City, CA (US); Heather Thorne, Boulder, CO (US); Bertrand Louis Rene Delorme, San Francisco, CA (US); Pedro Milani, Redwood City, CA (US)

(21) Appl. No.: 17/890,150

(22) Filed: Aug. 17, 2022

(51) Int. Cl. G06F 30/27

(52) U.S. Cl. CPC G06F 30/27; G06F 2113/08

(57) ABSTRACT

In an aspect, there is provided a method that includes: obtaining a physics-based ocean simulation model that specifies multiple simulation parameters, obtaining data characterizing an ocean in a geographical region, determining initial values of the simulation parameters based on data characterizing the ocean in the geographical region, and determining adjusted values of the simulation parameters. Determining adjusted values can include performing a simulation using the initial values of the simulation parameters to determine an initial simulation output, evaluating a task-specific objective function that is based on a measure of disagreement between: (i) the initial simulation output, and (ii) a target value for the ocean in the geographical region, and determining adjusted values of the simulation parameters of the physics-based ocean simulation model.

### BACKGROUND

This specification relates to physics-based ocean simulations that can solve partial differential equations to simulate physical properties of the ocean. The physical properties can include, for example, ocean currents, temperature, and salinity. In some cases, such physical properties can be coupled to biochemical quantities of the ocean, such as, for example, dissolved oxygen, nitrate, carbon dioxide, pH levels, and chlorophyll. All these quantities can be simulated in time on a three-dimensional grid representing an ocean, or a portion of the ocean, in a geographical region of interest.

Generally, physics-based ocean simulations can be very demanding in terms of computational resources. Numerous constraints can inhibit the ability to computationally resolve all the scales of oceanic flows. Various techniques such as parameterization are typically used to approximate the effects of small-scale turbulence, chemistry and biology that are difficult, or impossible, to resolve numerically. Therefore, the accuracy of physics-based ocean simulations relies heavily on appropriate choice of these parameterizations. Accordingly, there exists a growing need for systems and methods that can improve the accuracy of parameterization in physics-based ocean simulations.

### SUMMARY

This specification describes a method for fine-tuning simulation parameters of a physics-based ocean simulation model. The method can fine-tune the values of the simulation parameters based on a task-specific objective function that can be designed to fit a particular application of the ocean simulation model. For example, the task-specific objective function can be defined in terms of physical properties of the ocean in a particular region of the world such as, e.g., current, temperature, amount/concentration of oxygen and/or nitrate, or any other appropriate physical property of the ocean. After fine-tuning the values of the simulation parameters with respect to a particular geographical region of the world, the method described in this specification can perform ocean simulations using the fine-tuned simulation parameters for that geographical region. The simulations performed by the ocean simulation model using fine-tuned simulation parameters can be more accurate than ocean simulations performed using default, or standard, values of the simulation parameters.

The method can use the fine-tuned simulation parameters to generate an ocean simulation output, which can include, e.g., a predicted current, temperature, salinity, or any other appropriate physical aspect of the ocean in a particular geographical region of the world. The method can use the simulation output in conjunction with ocean and/or satellite data, and other models (e.g., machine learning models) to make further downstream predictions of physical quantities that are specific to the ocean in that geographical region.

As a particular example, the simulation output can include, e.g., data characterizing dissolved oxygen concentration in the ocean in the geographical region. The method described in this specification can provide the simulation output as an input to a machine learning model that can predict a likelihood of a harmful algae bloom in the ocean in that geographical region. Generally, harmful algae blooms can have a damaging effect on the ocean ecosystem and on aquaculture farms. By fine-tuning the simulation parameters of the ocean simulation model and using them to generate simulation outputs, the method described in this specification can not only improve the accuracy of these simulation outputs but also of downstream predictions generated by other models, e.g., machine learning models. For example, the method described in this specification can improve the ability to forecast harmful algae blooms, thereby effectively mitigating the damage caused by them.

It should be noted, however, that the aforementioned example is provided for illustrative purposes only. In general, the method described in this specification can fine-tune simulation parameters of the physics-based ocean simulation model based on any appropriate application of the model in any appropriate region of the world. Furthermore, the method can use the simulation parameters to perform ocean simulations to generate any appropriate ocean simulation output that may be useful for any appropriate downstream prediction.

According to a first aspect, there is provided a method performed by one or more data processing apparatus, the method including: obtaining a physics-based ocean simulation model that specifies multiple simulation parameters, obtaining data characterizing an ocean in a geographical region, determining initial values of the simulation parameters based on data characterizing the ocean in the geographical region, and determining adjusted values of the simulation parameters based on data characterizing the ocean in the geographical region. The method further includes: performing a simulation using the initial values of the simulation parameters to determine an initial simulation output for the ocean in the geographical region, evaluating a task-specific objective function that is based on a measure of disagreement between: (i) the initial simulation output determined by the simulation, and (ii) a target value for the ocean in the geographical region, and based on the evaluation of the task-specific objective function, determining adjusted values of the simulation parameters of the physics-based ocean simulation model.

In some implementations, the method further includes: obtaining data characterizing an ocean in another geographical region, determining initial values of the simulation parameters based on data characterizing the ocean in the other geographical region, and determining adjusted values of the simulation parameters based on data characterizing the ocean in the other geographical region.

In some implementations, the method further includes: training a machine learning model using the adjusted values of the simulation parameters determined based on data characterizing the ocean in the geographical region, and the adjusted values of the simulation parameters determined based on data characterizing the ocean in the other geographical region, to predict values of the simulation parameters for the ocean in a third geographical region.

In some implementations, the target value has been obtained using one or more sensors for the ocean in the geographical region.

In some implementations, the initial simulation output specifies a predicted ocean current in the geographical region, and wherein the target value specifies a measured ocean current in the geographical region.

In some implementations, the method further includes: performing a simulation using the adjusted values of the simulation parameters to determine a second simulation output for the ocean in the geographical region, and processing the second simulation output using a machine learning model to determine a predicted value of a physical property for the ocean in the geographical region.

In some implementations, the physical property for the ocean in the geographical region is an algae concentration in the ocean in the geographical region.

In some implementations, the second simulation output for the ocean in the geographical region and the physical property for the ocean in the geographical region are correlated.

In some implementations, processing the second simulation output using the machine learning model to determine the value of the physical property for the ocean in the geographical region includes: obtaining satellite data for the ocean in the geographical region, and processing the satellite data and the second simulation output to determine the value of the physical property for the ocean in the geographical region.

In some implementations, determining the initial values of the simulation parameters based on data characterizing the ocean in the geographical region includes: determining, for each simulation parameter, a respective set of distribution parameters that define a distribution over possible values for the simulation parameter based on data characterizing the ocean in the geographical region, and sampling each simulation parameter from the respective distribution in accordance with the respective set of distribution parameters.

In some implementations, determining adjusted values of the plurality of simulation parameters includes: adjusting, for each simulation parameter, the respective set of distribution parameters that define the distribution over possible values for the simulation parameter.

In some implementations, the method further includes: determining an overall uncertainty of the physics-based ocean simulation model based on the adjusted set of distribution parameters determined for each simulation parameter.

In some implementations, data characterizing the ocean in the geographical region comprises measurements obtained using one or more sensors for the ocean in the geographical region.

In some implementations, the target value of the physical parameter for the ocean in the geographical region has been obtained using one or more sensors.

In some implementations, the simulation parameters of the physics-based ocean simulation model comprise a viscosity coefficient and a diffusivity coefficient.

According to a second aspect, there is provided a system that includes: one or more computers, and one or more storage devices storing instructions that, when executed by the one or more computers, cause the one or more computers to perform the operations of any preceding aspect.

According to a third aspect, there is provided a non-transitory computer program product storing instructions that when executed by one or more computers cause the one or more computers to perform the operations of any preceding aspect.

Particular embodiments of the subject matter described in this specification can be implemented so as to realize one or more of the following advantages.

The parameterizations required in various parameterization schemes for physics-based ocean simulations have often been designed based on specific experiments that may not necessarily cover the physical processes of interest for a particular application, rendering them a significant source of uncertainty of current oceanic models. The systems and methods described in this specification can significantly improve the accuracy of ocean simulations by fine-tuning parameters used in the parameterization scheme directly based on data derived from a desired application of the model to a particular geographical region of the world. The systems and methods described in this specification employ data-driven techniques that can render the simulations more accurate and reduce the consumption of computational resources (e.g., memory and computing power) when making predictions.

Moreover, in order to perform accurate predictions, the physics-based ocean simulation models also rely on the accuracy of the atmospheric forcing and of the initial and boundary conditions. Initial and boundary conditions are typically built based on available observations and climatology of larger-scale ocean currents. Any error in the initial and boundary conditions is propagated and potentially amplified within the model, which can ultimately lead to large uncertainties in predictions.

The aforementioned limitations become even more important as the spatial resolution of the model increases because smaller-scale flows are typically more difficult to observe, making the use of physics-based ocean simulations very challenging for industrial coastal applications, or for future carbon accounting scenarios requiring higher resolution measurements. The systems and methods described in this specification can overcome the aforementioned challenges by fine-tuning ocean simulations by determining optimal values of simulation parameters for a particular application and a particular geographical region. Moreover, the systems and methods described in this specification enable quantification of uncertainty of the simulation model and associated forecasts by determining distributions around the optimal values of simulation parameters.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example data flow for adjusting simulation parameters of a physics-based ocean simulation model.

FIG. 2 is a block diagram of an example parameter tuning system that adjusts simulation parameters of a physics-based ocean simulation model.

FIG. 3 is a flow diagram of an example process for adjusting simulation parameters of a physics-based ocean simulation model.

FIG. 4 is a block diagram of an example computer system.

Like reference numbers and designations in the various drawings indicate like elements.

### DETAILED DESCRIPTION

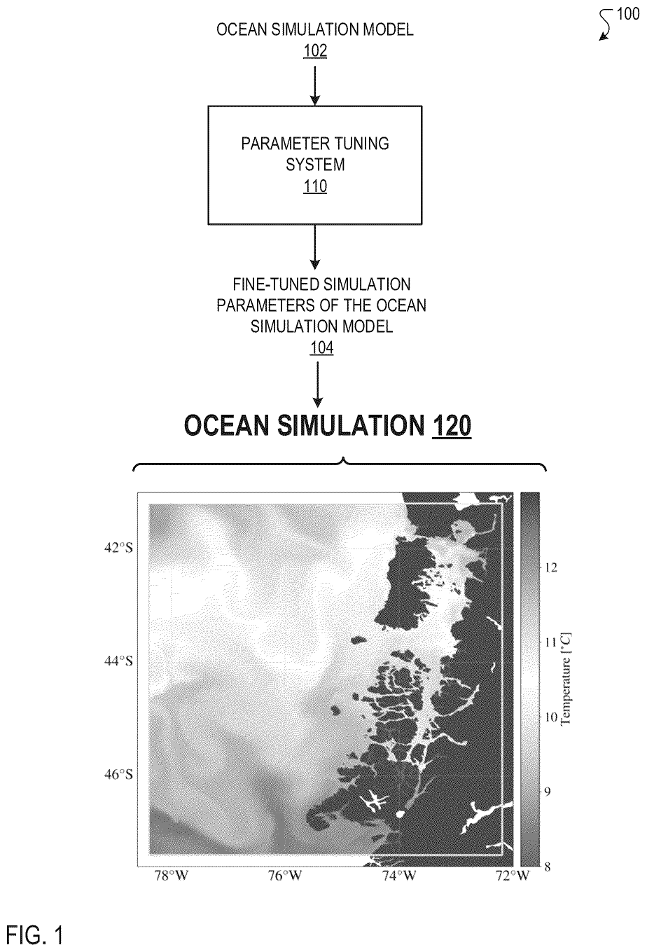

FIG. 1 is an example data flow 100 for adjusting simulation parameters of a physics-based ocean simulation model 102. The physics-based ocean simulation model 102 can be configured to simulate a physical state and dynamic properties of an ocean. Throughout this specification, an “ocean” can generally refer to any body of water in any appropriate geographical region of the world.

The physics-based ocean simulation model 102 can be defined in terms of partial differential equations that model physical properties of the ocean. Throughout this specification, “simulating” a physical state of the ocean can refer to solving these partial differential equations using a numerical solver, which can be any appropriate numerical solver. Example ocean simulation model and numerical solver are described with reference to: S. Jullien et al., “CROCO Technical and numerical doc Release 1.2,” http://www.croco-ocean.org.”

In some cases, the physics-based ocean simulation model 102 can include multiple different types of models that are linked together, e.g., models based on Navier Stokes equations for ocean current predictions, biogeochemical models for phytoplankton growth predictions, wave height models, or any other appropriate models. Each of these models can have an associated set of parameters. Throughout this specification, the respective sets of parameters of these models are collectively referred to as simulation parameters of the physics-based ocean simulation model 102. Furthermore, the physics-based ocean simulation model 102 can be configured to simulate any appropriate physical property of the ocean such as, e.g., current, temperature, dissolved concentration of oxygen and/or nitrate, salinity, or any other appropriate physical property of the ocean.

As illustrated in FIG. 1, the physics-based ocean simulation model 102 can be configured to simulate physical properties of the ocean in time on a grid, e.g., a three-dimensional grid that specifies depth, latitude, and longitude. In the example of FIG. 1, the ocean simulation model 102 is illustrated as simulating a sea surface temperature off the Chilean coast. In some cases, the ocean simulation model 102 can simulate physical properties of the ocean using a process called “nesting.” In this process, physical properties of a larger region of the ocean are simulated on a larger grid (e.g., a “parent” grid) with lower spatial resolution, while physical properties of a smaller region of interest that forms a part of the larger region of the ocean are simulated on a smaller grid (e.g., a “child” grid, or a sub-grid) with higher spatial resolution. In this configuration, data generated by the parent grid simulation can supply boundary and initial conditions to the sub-grid simulation.

The sub-grid simulation can run independently from the parent grid simulation and at a much higher spatial resolution, allowing for a better representation of the smaller scale processes while simultaneously reducing the consumption of computational resources (e.g., memory and computing power). By performing simulations using the process of nesting, the physics-based ocean simulation model 102 can resolve higher resolution details such as turbulent mixing at a location of interest, e.g., near a coastline, while simultaneously preserving the simulation of regional-scale circulation of the ocean at a lower resolution. Example simulations that employ nesting are described in more detail with reference to: Delorme, Bertrand L., et al., “Enhanced Abyssal Mixing in the Equatorial Pacific Associated with Non-Traditional Effects,” Journal of Physical Oceanography 51, 6 (2021): 1895-1914, accessed Jul. 19, 2022, doi: 10.1175/JPO-D-20-0238.1.

While turbulent mixing occurs on smaller scales than ocean circulation, it is an important quantity in ocean simulations because it has a direct influence on larger-scale oceanic circulation. The ocean simulation model 102 captures turbulent mixing in sub-grid simulations described above through a sub-grid parameterization scheme. This scheme allows to determine viscosity and diffusivity coefficients that can simulate mixing water properties and accordingly represent turbulent flows at the model resolution. The ocean simulation model 102 can employ sub-grid parameterization to determine the values of viscosity and diffusivity coefficients, thereby facilitating realistic simulations of turbulent mixing. An example of the parameterization scheme is described in more detail with reference to: Large, W. G., McWilliams, J. C., and Doney, S. C. (1994), Oceanic vertical mixing: A review and a model with a nonlocal boundary layer parameterization, Rev. Geophys., 32(4), 363-403, doi:10.1029/94RG01872.

The parameterization scheme of the ocean simulation model 102 can be divided into a surface boundary layer component and an interior component. The surface boundary layer can refer to, e.g., an upper 100 meters of the ocean from the ocean's surface, and the interior can refer to, e.g., the part of the ocean that is below the surface boundary layer. The surface boundary layer component of the parameterization scheme can estimate a viscosity coefficient vₓ in the surface boundary layer of the ocean as follows:

vₓ=h_{sbl}wₓ(σ)Gₓ(σ) (1)

where the subscript x stands for one of momentum, temperature, and salinity, h_{sbl} is a surface boundary layer depth, wₓ(σ) is a turbulent velocity scale, Gₓ(σ) is a non-dimensional shape function which can be, e.g., a third order polynomial, and σ is a non-dimensional coordinate between 0 and 1 indicating a depth within the surface boundary layer. The interior component of the parameterization scheme can estimate the viscosity coefficient vₓ in the interior of the ocean by adding effects due to shear mixing, double-diffusive mixing, and internal wave generated mixing as follows:

vₓ(d)=vₓ^{s}+vₓ^{d}+vₓ^{w} (2)

where vₓ^{s} is the viscosity coefficient due to shear mixing, vₓ^{d} is the viscosity coefficient due to double-diffusive mixing, and vₓ^{w} is the viscosity coefficient due to internal wave generated mixing. In some cases, the parameterization scheme of the ocean simulation model 102 can estimate the coefficients in equation (1) and equation (2) above using parameters that are set empirically. As a particular example, the viscosity coefficient due to shear mixing vₓ^{s} in equation (2) above can be estimated as follows:

$${v}_{x}^{s} = \{ \begin{matrix}{v}_{0} & {Ri}_{g} < 0 \\ {{v}_{0} [ 1 - {( R {i}_{g} / {Ri}_{0} )}^{2} ]}^{3} & 0 < R {i}_{g} < R {i}_{0} \\ 0 & {Ri}_{g} > R {i}_{0}\end{matrix} \qquad ( 3 )$$

where v₀=5.0×10⁻³, Ri₀=0.7, and Ri_{g} is the gradient Richardson number. The Ri₀ parameter is set empirically and defines a threshold below which a non-zero value for the viscosity coefficient is set. The v₀ parameter is also set empirically and it represents a maximum viscosity coefficient allowed for mixing due to shear instability. Some, or all, of the coefficients in equations (1) and (2) above can be similarly estimated based on empirical parameters. An example parameterization scheme of the ocean simulation model 102 is described in more detail with reference to: Large, W. G., McWilliams, J. C., and Doney, S. C. (1994), Oceanic vertical mixing: A review and a model with a nonlocal boundary layer parameterization, Rev. Geophys., 32(4), 363-403, doi:10.1029/94RG01872.

A parameter tuning system 110 can adjust, or fine-tune, the simulation parameters of the ocean simulation model 102 (e.g., v₀ and Ri₀ in equation (3) above, and other simulation parameters) based on a specific application of the model 102 and with respect to a specific geographical region of the world. By fine-tuning these parameters instead of, e.g., using the default values, the parameter tuning system 100 can significantly increase the accuracy of forecasting and predictions generated by the ocean simulation model 102 with respect to a specific application of the simulation model 102 and a specific geographical region of the world.

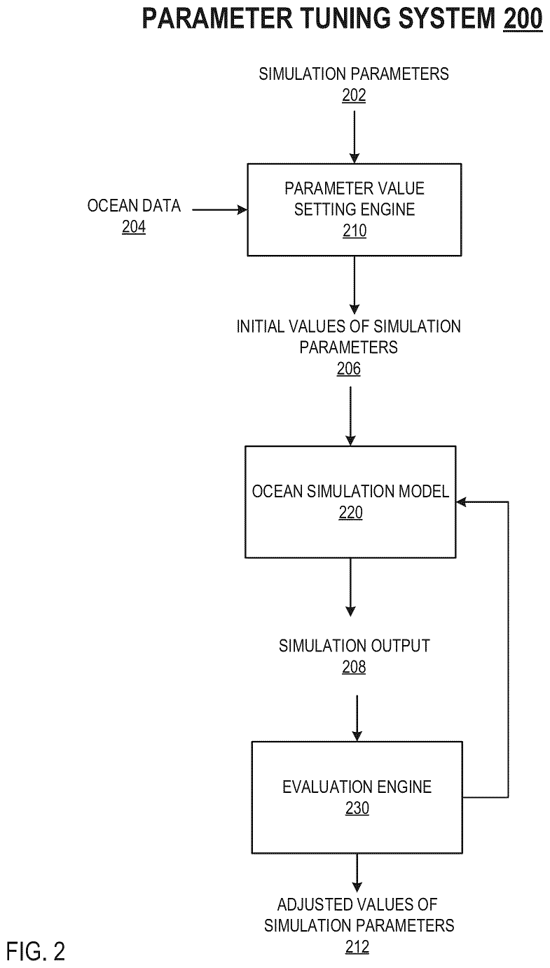

As described in more detail below with reference to FIG. 2, the parameter tuning system 102 can determine, for each simulation parameter of the ocean simulation model 102, a respective set of distribution parameters that define a distribution over possible values for the simulation parameter based on data characterizing an ocean in the geographical region. The parameter tuning system 110 can obtain ocean data from any appropriate source. The ocean data can include, for example, default values for the simulation parameters as described above with reference to equation (3). The ocean data can also include, for example, salinity, temperature, and/or oxygen concentration data within the water column. The parameter tuning system 110 can adjust, for each simulation parameter, the respective set of distribution parameters that define the distribution over possible values for the simulation parameter.

In order to adjust the simulation parameters, the parameter tuning system 110 can evaluate a task-specific objective function that is defined with respect to a particular application of the ocean simulation model 102, which can be any appropriate application of the ocean simulation model 102. In particular, the task-specific objective function can be based on a measure of disagreement between: (i) an initial simulation output determined by the simulation that is performed using initial (e.g., default) values of simulation parameters, and (ii) a target value for the ocean in the geographical region. In some cases, the target value for the ocean in the geographical region has been measured directly using one or more sensors. As a particular example, the initial simulation output can include data characterizing an ocean current in a particular region of the world, and the target value can specify the ocean current that has been measured directly using one or more sensors in that region of the world.

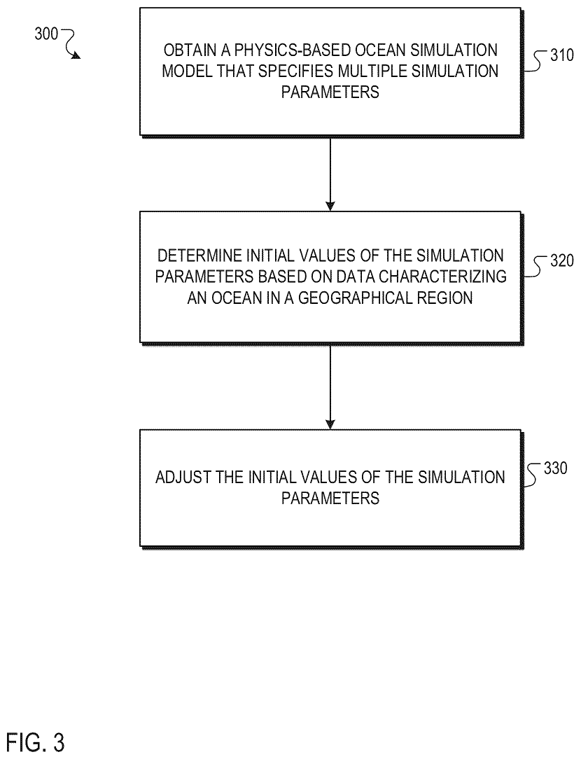

By evaluating such objective function, the parameter tuning system 110 can generate adjusted simulation parameters (e.g., viscosity and diffusivity coefficients) that are specific to a particular region of the world. Accordingly, when the ocean simulations 102 are performed using the fine-tuned simulation parameters 104, the ocean simulation 102 can more accurately represent physical processes (e.g., oceanic flows) in that region of the world. Furthermore, as described in more detail below with reference to FIG. 3, the simulation output of the ocean simulation model 102, generated using fine-tuned simulation parameters 104, can be used to make further downstream predictions for the ocean in that region of the world. For example, the simulation output can be used in conjunction with ocean/satellite data, and other models (e.g., machine learning models) to make further downstream predictions of various physical properties that, in some cases, may not necessarily be simulated by the ocean simulation model 102 directly.

As a particular example, the simulation output of the ocean simulation model 102 can include, e.g., dissolved oxygen concentration in the ocean in a particular region of the world. As described below with reference to FIG. 3, a machine learning model can process this simulation output to generate a prediction of algae concentration of various algae species in that geographical region. Because the machine learning model makes this prediction using the simulation output of the simulation performed with fine-tuned simulation parameters 104, the prediction of the machine learning model can be more accurate. Therefore, the model can more accurately forecast harmful algae blooms, allowing to effectively mitigate damage caused by them.

Example applications of the ocean simulation model 102 with fine-tuned simulation parameters are described in more detail next.

In some implementations, the simulation output of the ocean simulation model 102 can be used to predict algae concentration for an ocean in a geographical region. Generally, algae blooms can have a damaging effect on the local ocean ecosystem and on aquaculture farms. The ocean simulation model 102 with fine-tuned simulation parameters based on local data can be used to forecast harmful algae blooms in a particular geographical region of the world.

In some implementations, the simulation output of the ocean simulation model 102 can be used to track pollutants in an ocean in a geographical region. When there is a pollution source (e.g. an oil spill), various resources are often deployed to try to mitigate the effects of the pollution (e.g. clean up the oil). The ocean simulation model 102 can be used to simulate oceanic currents in a specific geographical region to optimize resource deployment based on pollutant transport in the ocean over a particular time period. Furthermore, the simulation with fine-tuned simulation parameters of one polluting event could be used to improve simulations and predictions for future polluting events.

In some implementations, the simulation output of the ocean simulation model 102 can be used for predictive maintenance of hardware, and predictive software reliability. For example, the ocean simulation model can be used to simulate ocean conditions that equipment has been subjected to (or to forecast the conditions it's likely to be subjected to) as part of a system that would determine what maintenance should be applied to hardware and when. Furthermore, the simulation output of the ocean simulation model 102 can be used to simulate conditions under which software (e.g., perception algorithms used to obtain data underwater) failed to provide an accurate prediction, and determine a threshold under which the uncertainty associated with the software becomes too high (for example, under rough ocean/weather conditions).

In some implementations, the simulation output of the ocean simulation model 102 can be used for carbon sequestration monitoring. For example, in measurements of air-sea carbon dioxide transfer, the simulation output can be used to reduce the need for costly experiments. Instead of directly measuring turbulent fluxes of carbon dioxide, the concentration in the water and the air could be measured and then the simulation could be optimized to determine what the turbulent fluxes were observed. Such simulations can give an estimate of how carbon is transported in the ocean.

In some implementations, the simulation output of the ocean simulation model 102 can be used for site optimization in ocean industries. For many ocean industries, it is important to determine where a given asset should be placed. Accordingly, the simulation output can be used to perform simulations to optimize not only for economic outcomes, but also for environmental impact of various sites based on ocean conditions and climate change projections. Such simulations could facilitate a reconstruction of historical environmental history of an asset. For example, the simulation output can be used to understand the difference in growth rate of fish between two pen locations based on the environmental data.

In some implementations, the simulation output of the ocean simulation model 102 can be used for risk forecasting for insurance purposes and attribution. Insurance companies may be interested in the potential impact of e.g. an oil leak. The simulations performed by the ocean simulation model 102 can be used to forecast the impact of such events. Furthermore, the simulations can be used to help with attribution to determine the likelihood that one of these events yielded damage being reported in a claim.

In some implementations, the simulation output of the ocean simulation model 102 can be used for aquaculture operational optimization. The simulation output can be used to determine operational decisions within aquaculture such as harvest timing, feeding rates, and others, based on predicted environmental conditions and impact. The simulations can also be used to determine correlation between aquaculture operational decisions and environmental conditions to determine which decisions are optimal.

In some implementations, the simulation output of the ocean simulation model 102 can be used for microplastic forecasting and collection optimization. The simulations performed by the ocean simulation model 102 can be used to predict how microplastics could aggregate and how various collection approaches might be able to concentrate the microplastics for collection.

In some implementations, the simulation output of the ocean simulation model 102 can be used for data collection optimization. For example, the ocean simulation model 102 can provide uncertainty estimates for its predictions, such that sensors could be placed optimally to collect data to best inform simulation accuracy.

In some implementations, the simulation output of the ocean simulation model 102 can be used for route optimization for ships for fuel and time savings. The simulations can be used to find the optimal navigation route for ships so that fuel and time are saved (cheaper navigation and less carbon emissions). Furthermore, when a cargo or a person has been lost overboard, the simulations performed by the ocean simulation model 102 can predict their location based on oceanic flow predictions.

By fine-tuning the simulation parameters as described above, the system described in this specification can use the ocean simulation model 102 to perform ocean simulations and generate accurate predictions in all applications described above. Moreover, other applications of the ocean simulation model 102 with fine-tuned simulation parameters 104 are also possible.

The parameter tuning system 110 is described in more detail next.

FIG. 2 is a block diagram of an example parameter tuning system 200 (e.g., the parameter tuning system 110 in FIG. 1) that adjusts simulation parameters 202 of a physics-based ocean simulation model 220 (e.g., the ocean simulation model 102 in FIG. 1). The parameter tuning system 200 is an example of a system implemented as computer programs on one or more computers in one or more locations in which the systems, components, and techniques described below are implemented.

The parameter tuning system 200 can process the simulation parameters 202 of the ocean simulation model 220 and generate adjusted values of the simulation parameters 212 using: (i) a parameter value setting engine 210 and (ii) an evaluation engine 230, each of which is described in more detail next.

The parameter value setting engine 210 can be configured to set initial values of the simulation parameters 206 based on ocean data 204 characterizing an ocean in a geographical region. As described above, ocean data 204 can be any appropriate data characterizing the ocean in a geographical region and can generally specify default values of simulation parameters, e.g., as described above with reference to equation (3). The parameter value setting engine 210 can determine, for each simulation parameter, a respective set of distribution parameters that define a distribution over possible values for the simulation parameter based on data characterizing the ocean in the geographical region. As a particular example, for each simulation parameter, the parameter value setting engine 210 can determine the set of distribution parameters by using a Normal distribution, e.g., by centering the Normal distribution on the default value of the simulation parameter that is specified in the ocean data 204. Generally, the parameter value setting engine 210 can determine the distribution parameters in any other appropriate manner.

After determining the set of distribution parameters for each simulation parameter, the parameter value setting engine 210 can sample (e.g., randomly) a value of each simulation parameter from the respective distribution in accordance with the respective set of distribution parameters. For each simulation parameter, the engine 210 can set the sampled value as the initial value of the simulation parameter. In this manner, the parameter value setting engine 210 can determine the initial values of simulation parameters 206 of the ocean simulation model 220.

After setting the initial values of simulation parameters, the parameter tuning system 200 can use them to perform a simulation using the ocean simulation model 220 to determine a simulation output 208 for the ocean in the geographical region. The simulation output 208 can include data that characterizes any appropriate physical aspect of the ocean in the geographical region. For example, the simulation output 208 can include data that specifies, e.g., predicted current, temperature, amount/concentration of oxygen and/or nitrate, or any other appropriate physical property of the ocean.

The parameter tuning system 200 can provide the simulation output 208 to the evaluation engine 230. The evaluation engine 230 can be configured to evaluate a task-specific objective function that is based on a measure of disagreement between: (i) the simulation output 208 determined by the simulation, and (ii) a target value for the ocean in the geographical region. In some cases, the target value for the ocean in the geographical region has been measured using one or more sensors in the ocean in the geographical region, determined from satellite data, or obtained in any other appropriate manner. As a particular example, the simulation output 208 can specify, e.g., a predicted ocean current in the geographical region, while the target value can specify, e.g., a measured ocean current in the geographical region.

Based on evaluating the task-specific objective function, the evaluation engine can generate adjusted values of simulation parameters 212 of the ocean simulation model 220. For example, the evaluation engine 230 can adjust, for each simulation parameter, the respective set of distribution parameters that define the distribution over possible values for the simulation parameter. The parameter tuning system 200 can repeat this process over multiple iterations in order to minimize the task-specific objective function and further adjust the simulation parameters of the ocean simulation model. After the simulation parameters of the ocean simulation model 220 have been adjusted, the ocean simulation model 220 can be used to perform ocean simulations for the ocean in the geographical region using the adjusted simulation parameters. Simulations performed using the adjusted simulation parameters 112 can be more accurate than simulations performed using default values of simulation parameters, because the adjusted simulation parameters 112 are generated based on a particular application of the ocean simulation model 220 that is specific to a particular region of the world.

In some implementations, the parameter tuning system 200 can iteratively adjust the simulation parameters of the ocean simulation model 220. For example, the system 200 can set the adjusted values of the simulation parameters as the initial values 206 of the simulation parameters and perform a second simulation using the ocean simulation model 220 to generate a second simulation output 208. Based on the second simulation output 208, the evaluation engine 230 can again adjust the simulation parameters of the ocean simulation model 220. The system 200 can terminate this process after a termination criterion is satisfied. The termination criterion can be any appropriate criterion, e.g., it can specify a particular number of iterations. At the final iteration, the system 200 can generate final simulation parameter values of the ocean simulation model 220 and use them to perform ocean simulations and, in some cases, generate downstream predictions using other models (e.g., machine learning models). In this manner, the system 200 can fine-tune simulation parameters of the ocean simulation model 220 such that, when the ocean simulations are performed using the fine-tuned simulation parameters, the simulation output 208 accurately represents physical processes in the ocean in the geographical region.

An example process for adjusting simulation parameters of the physics-based ocean simulation model 220 is described in more detail next.

FIG. 3 is a flow diagram of an example process 300 for adjusting simulation parameters of a physics-based ocean simulation model. For convenience, the process 300 is described as being performed by a system of one or more computers located in one or more locations. For example, a parameter tuning system, e.g., the parameter tuning system 110 of FIG. 1, the parameter tuning system 200 of FIG. 2, appropriately programmed in accordance with this specification, can perform the process 300.

The system obtains a physics-based ocean simulation model that specifies multiple simulation parameters (310). As described above with reference to FIG. 1, the ocean simulation model can include a parameterization scheme that is defined in terms of viscosity and diffusivity coefficients that can be used to simulate mixing water properties and turbulent flows at the model resolution. These viscosity and diffusivity coefficients can be defined in terms of multiple parameters (e.g., as shown in equation (3) above) that can represent the simulation parameters of the ocean simulation model. In some implementations, the system can further obtain data characterizing an ocean in a geographical region.

The system determines initial values of the simulation parameters based on data characterizing the ocean in the geographical region (320). For example, the system can determine, for each simulation parameter, a respective set of distribution parameters that define a distribution over possible values for the simulation parameter based on data characterizing the ocean in the geographical region. Then, the system can sample each simulation parameter from the respective distribution in accordance with the respective set of distribution parameters. For each simulation parameter, the system can set the sampled value as the initial value of the simulation parameter.

The system adjusts the initial values of the simulation parameters (330). For example, the system can perform a simulation using the initial values of the simulation parameters to determine an initial simulation output for the ocean in the geographical region. The initial simulation output can specify any appropriate physical property of the ocean in the geographical region simulated by the ocean simulation model. As a particular example, the simulation output can include, e.g., predicted current, temperature, amount/concentration of oxygen and/or nitrate, or any other appropriate physical property of the ocean.

The system can evaluate a task-specific objective function that is based on a measure of disagreement between: (i) the initial simulation output determined by the simulation, and (ii) a target value for the ocean in the geographical region. In some cases, the target value for the ocean in the geographical region has been obtained using one or more sensors. In other words, the target value can represent a measured value of the current, temperature, amount/concentration of oxygen and/or nitrate, or any other appropriate physical property of the ocean in the geographical region. As a particular example, the initial simulation output of the ocean simulation model can specify a predicted ocean current in the geographical region, and the target value for the ocean in the geographical region can specify a measured ocean current in the geographical region.

Based on the evaluation of the task-specific objective function, the system can determine the adjusted values of the simulation parameters of the physics based ocean simulation model. In one example, the system can adjust, for each simulation parameter, the respective set of distribution parameters that define the distribution over possible values for the simulation parameter.

In some implementations, the system can obtain data characterizing an ocean in another geographical region, e.g., a geographical region that is different from the region for which the system initially determines the simulation parameters of the ocean simulation model. The system can determine initial values of the simulation parameters based on data characterizing the ocean in the other geographical region, e.g., in a similar way as described above. Then, the system can determine adjusted values of the simulation parameters based on data characterizing the ocean in the other geographical region. As a particular example, the system can perform a simulation using the initial values of the simulation parameters to determine an initial simulation output for the ocean in the other geographical region, evaluate the task-specific objective function that is based on a measure of disagreement between: (i) the initial simulation output determined by the simulation, and (ii) a target value for the ocean in the other geographical region. Then, based on the evaluation of the task-specific objective function, the system can determine adjusted values of the simulation parameters of the physics-based ocean simulation model. However, in this case, the system can adjust the parameters of the ocean simulation model based on data characterizing the ocean in the other geographical region.

After determining adjusted simulation parameters based on data characterizing the ocean in the geographical region, and adjusted simulation parameters determined based on data characterizing the ocean in the other geographical region, the system can train a machine learning model to predict values of the simulation parameters for the ocean in a third geographical region. In such cases, the third geographical region can be different from the geographical regions for which the system determines the adjusted simulation parameters, e.g., as described above. The system can use the adjusted simulation parameters determined for respective geographical regions as training data for training the machine learning model using, e.g., supervised learning techniques.

For example, the training data can include a set of training examples, where each training example specifies: (i) a training input that can be processed by the machine learning model, and (ii) a target output that should be generated by the machine learning model by processing the training input. As a particular example, the training input can specify local geographical characteristics for an ocean in a geographical region of the world (e.g., local topography or coastal flow dynamics), and the target output can specify the adjusted simulation parameters of the physics-based ocean simulation model (e.g., a viscosity coefficient and a diffusivity coefficient). In other words, the target output can specify, e.g., optimal simulation parameters for simulating the ocean physics for the input local topography or coastal flow dynamics.

After training the machine learning model in this manner, the system can use it to predict simulation parameters of the physics-based ocean simulation model for the ocean in any geographical region of the world (e.g., any local topography and local flow dynamics). In some cases, the machine learning model can additionally process satellite data, ocean data, or any other appropriate data, in order to predict the adjusted simulation parameters of the physics-based ocean simulation model.

In some implementations, the system can perform a simulation using the adjusted values of the simulation parameters to determine a second simulation output for the ocean in the geographical region. Because the system adjusts the simulation parameters based on the evaluation of the task-specific objective function, in some cases, the second simulation output can more accurately represent physical properties of the ocean in the geographical region than the initial simulation output (e.g., generated by the simulation model using initial, or default, simulation parameters). The system can process the second simulation output using a machine learning model to determine a predicted value of a physical property for the ocean in the geographical region. The machine learning model can be any appropriate model that can predict a physical property of the ocean.

As a particular example, the second simulation output can specify one or more of: concentration/amount of nitrate, oxygen, temperature, and current information for the ocean in the geographical region. Such physical properties can be correlated with other physical properties in the ocean, e.g., a concentration of various algae species. The machine learning model can be configured to process the second simulation output, and any other appropriate ocean or satellite data, to predict an algae concentration of various algae species in the ocean in the geographical region. In this manner, the system can perform simulations using adjusted simulation parameters to generate a simulation output, and use the simulation output to make other predictions about physical properties of the ocean, e.g., predictions that may be difficult to infer directly using ocean simulations.

Because the system generates the simulation output using adjusted simulation parameters, the system can generate downstream predictions of other physical properties of the ocean (e.g., using machine learning models) that are more accurate. For example, the system can more accurately forecast harmful algae blooms.

In some implementations, the system can determine an overall uncertainty of the physics-based ocean simulation model based on the adjusted set of distribution parameters determined for each simulation parameter. For example, the system can use a Bayesian approach to determine a posterior distribution of a simulation parameter after optimization with respect to the objective function.

An example computer system that can be used to implement the process 300 is described in more detail next.

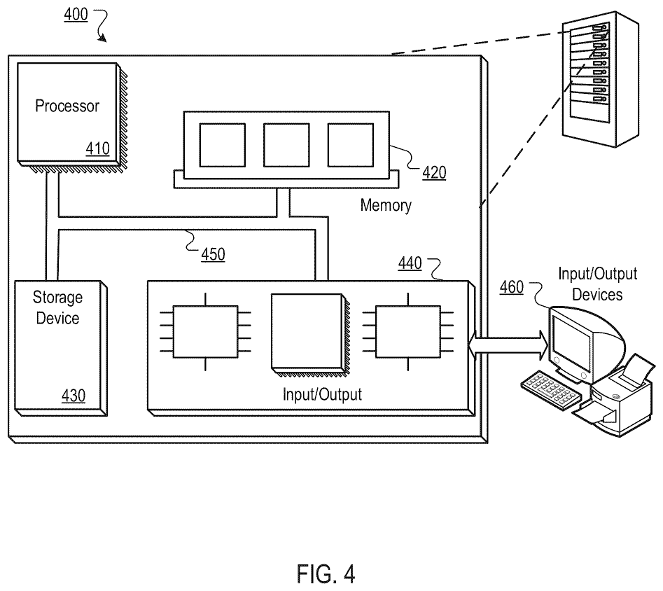

FIG. 4 is a block diagram of an example computer system 400 that can be used to perform operations described previously. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (for example, a cloud storage device), or some other large capacity storage device.

The input/output device 440 provides input/output operations for the system 400. In one implementation, the input/output device 440 can include one or more network interface devices, for example, an Ethernet card, a serial communication device, for example, and RS-232 port, and/or a wireless interface device, for example, and 802.11 card. In another implementation, the input/output device 440 can include driver devices configured to receive input data and send output data to other input/output devices, for example, keyboard, printer and display devices 460. Other implementations, however, can also be used, such as mobile computing devices, mobile communication devices, and set-top box television client devices.

Although an example processing system has been described in FIG. 9, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which can also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program can, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A method performed by one or more data processing apparatus, the method comprising:
obtaining a physics-based ocean simulation model that specifies a plurality of simulation parameters;
obtaining data characterizing an ocean in a geographical region;
determining initial values of the plurality of simulation parameters based on data characterizing the ocean in the geographical region; and
determining adjusted values of the plurality of simulation parameters based on data characterizing the ocean in the geographical region, comprising:
performing a simulation using the initial values of the plurality of simulation parameters to determine an initial simulation output for the ocean in the geographical region;
evaluating a task-specific objective function that is based on a measure of disagreement between: (i) the initial simulation output determined by the simulation, and (ii) a target value for the ocean in the geographical region; and
based on the evaluation of the task-specific objective function, determining adjusted values of the plurality of simulation parameters of the physics-based ocean simulation model.

2. The method of claim 1, further comprising:
obtaining data characterizing an ocean in another geographical region;
determining initial values of the plurality of simulation parameters based on data characterizing the ocean in the other geographical region; and
determining adjusted values of the plurality of simulation parameters based on data characterizing the ocean in the other geographical region.

3. The method of claim 2, further comprising:
training a machine learning model using the adjusted values of the plurality of simulation parameters determined based on data characterizing the ocean in the geographical region, and the adjusted values of the plurality of simulation parameters determined based on data characterizing the ocean in the other geographical region, to predict values of the plurality of simulation parameters for the ocean in a third geographical region.

4. The method of claim 1, wherein the target value has been obtained using one or more sensors for the ocean in the geographical region.

5. The method of claim 1, wherein the initial simulation output specifies a predicted ocean current in the geographical region, and wherein the target value specifies a measured ocean current in the geographical region.

6. The method of claim 1, further comprising:
performing a simulation using the adjusted values of the plurality of simulation parameters to determine a second simulation output for the ocean in the geographical region; and
processing the second simulation output using a machine learning model to determine a predicted value of a physical property for the ocean in the geographical region.

7. The method of claim 6, wherein the physical property for the ocean in the geographical region is an algae concentration in the ocean in the geographical region.

8. The method of claim 6, wherein the second simulation output for the ocean in the geographical region and the physical property for the ocean in the geographical region are correlated.

9. The method of claim 6, wherein processing the second simulation output using the machine learning model to determine the value of the physical property for the ocean in the geographical region comprises:
obtaining satellite data for the ocean in the geographical region; and
processing the satellite data and the second simulation output to determine the value of the physical property for the ocean in the geographical region.

10. The method of claim 1, wherein determining the initial values of the plurality of simulation parameters based on data characterizing the ocean in the geographical region comprises:
determining, for each simulation parameter, a respective set of distribution parameters that define a distribution over possible values for the simulation parameter based on data characterizing the ocean in the geographical region; and
sampling each simulation parameter from the respective distribution in accordance with the respective set of distribution parameters.

11. The method of claim 10, wherein determining adjusted values of the plurality of simulation parameters comprises:
adjusting, for each simulation parameter, the respective set of distribution parameters that define the distribution over possible values for the simulation parameter.

12. The method of claim 11, further comprising:
determining an overall uncertainty of the physics-based ocean simulation model based on the adjusted set of distribution parameters determined for each simulation parameter.

13. The method of claim 1, wherein data characterizing the ocean in the geographical region comprises measurements obtained using one or more sensors for the ocean in the geographical region.

14. The method of claim 1, wherein the target value of the physical parameter for the ocean in the geographical region has been obtained using one or more sensors.

15. The method of claim 1, wherein the simulation parameters of the physics-based ocean simulation model comprise a viscosity coefficient and a diffusivity coefficient.

16. A system comprising:
one or more computers, and
one or more storage devices storing instructions that, when executed by the one or more computers, cause the one or more computers to perform operations comprising:
obtaining a physics-based ocean simulation model that specifies a plurality of simulation parameters;
obtaining data characterizing an ocean in a geographical region;
determining initial values of the plurality of simulation parameters based on data characterizing the ocean in the geographical region; and
determining adjusted values of the plurality of simulation parameters based on data characterizing the ocean in the geographical region, comprising:
performing a simulation using the initial values of the plurality of simulation parameters to determine an initial simulation output for the ocean in the geographical region;
evaluating a task-specific objective function that is based on a measure of disagreement between: (i) the initial simulation output determined by the simulation, and (ii) a target value for the ocean in the geographical region; and
based on the evaluation of the task-specific objective function, determining adjusted values of the plurality of simulation parameters of the physics-based ocean simulation model.

17. A non-transitory computer program product storing instructions that when executed by one or more computers cause the one or more computers to perform operations comprising:
obtaining a physics-based ocean simulation model that specifies a plurality of simulation parameters;
obtaining data characterizing an ocean in a geographical region;
determining initial values of the plurality of simulation parameters based on data characterizing the ocean in the geographical region; and
determining adjusted values of the plurality of simulation parameters based on data characterizing the ocean in the geographical region, comprising:
performing a simulation using the initial values of the plurality of simulation parameters to determine an initial simulation output for the ocean in the geographical region;
evaluating a task-specific objective function that is based on a measure of disagreement between: (i) the initial simulation output determined by the simulation, and (ii) a target value for the ocean in the geographical region; and
based on the evaluation of the task-specific objective function, determining adjusted values of the plurality of simulation parameters of the physics-based ocean simulation model.

18. The non-transitory computer program product of claim 17, wherein data characterizing the ocean in the geographical region comprises measurements obtained using one or more sensors for the ocean in the geographical region.

19. The non-transitory computer program product of claim 17, wherein the target value of the physical parameter for the ocean in the geographical region has been obtained using one or more sensors.

20. The non-transitory computer program product of claim 17, wherein the simulation parameters of the physics-based ocean simulation model comprise a viscosity coefficient and a diffusivity coefficient.
